(19) United States
(12) Patent Application Publication
(10) Pub. No.: US 2008/0020225 A1
(43) Pub. Date: Jan. 24, 2008

(54) Discharge Electrode Clad Material And Discharge Electrode

(76) Inventors: Tomohiro Saito, Osaka (JP); Hiroshi Miura, Hyogo (JP); Masaaki Ishio, Osaka (JP); Tsuyoshi Hasegawa, Osaka (JP)

Correspondence Address: NEOMAX CO., LTD.;C/O KEATING & BENNETT, LLP, 8180 GREENSBORO DRIVE, SUITE 850, MCLEAN, VA, 22102, US

(21) Appl. No.: 10/595,811

(22) PCT Filed: Nov. 8, 2004
(86) PCT No.: PCT/JP04/16519

§ 371 Date: Feb. 5, 2007

(30) Foreign Application Priority Data
Nov. 13, 2003 (JP) 2003-383241

(51) Int. Cl. H01J 61/067; H01J 9/02

(52) U.S. Cl. 428/573; 428/586; 428/615; 428/679; 428/680

(57) ABSTRACT

A discharge electrode material is provided, which enable to form a discharge electrode having a service life and discharge characteristics equivalent to those of a discharge electrode mainly composed of Nb and having excellent weldability to a support conductor, and enables to reduce material costs. The discharge electrode clad material according to the present invention includes a base layer composed of pure Ni, a Ni-based alloy mainly comprising Ni or a stainless steel, and a surface layer bonded to the base layer and composed of pure Nb or a Nb-based alloy mainly comprising Nb. The clad material preferably further includes an intermediate layer provided between the base layer and the surface layer and composed of a stainless steel. The base layer may have a strip-like shape, and the surface layer may be disposed only on a middle portion of the base layer.

### BACKGROUND OF THE INVENTION

1. Field of the Invention

The present invention relates to a discharge electrode for a fluorescent discharge tube to be used, for example, as a back light of a liquid crystal display, and an electrode material for the discharge electrode.

2. Description of the Related Art

A small size fluorescent discharge tube is used as a back light for a liquid crystal device. As shown in FIG. 7, the fluorescent discharge tube includes a glass tube 51 having a fluorescent film (not shown) provided on an interior surface thereof and containing a discharge gas (a mercury vapor and a noble gas such as argon gas) confined therein, and a pair of discharge electrodes 52 provided as cold cathodes on opposite ends of the glass tube 51. The discharge electrodes 52 each have a cup shape, including a tubular portion 53 having an open end and an end plate portion 54 that is integral with the tubular portion 53 to close the other end of the tubular portion 53. A stem-like support conductor 55 is hermetically arranged through an end portion of the glass tube 51 with one end thereof welded to the end plate portion 54 and with the other end thereof connected to a lead wire 57. The support conductor 55 is generally composed of W (tungsten), and typically laser-welded to the discharge electrode 52 in air.

The discharge electrode 52 is conventionally composed of pure Ni, and has an inner diameter of about 1.5 mm, a length of about 5 mm and a wall thickness of the tubular portion 53 of about 0.1 mm, for example, for the small fluorescent discharge tube to be used as the back light. The discharge electrode 52 is typically formed unitarily from a pure Ni thin plate having the same thickness as the tubular portion by deep drawing.

The pure Ni, which is a stable material that has excellent formability, is used for the formation of the discharge electrodes for the fluorescent discharge tube as described above, but the fluorescent discharge tube with discharge electrodes made of pure Ni is disadvantageous in that the electrodes have a relatively short service life. That is, when the fluorescent discharge tube turns on a light, a sputtering phenomenon occurs in which the electrodes are bombarded with ions and the like to release atoms of the electrode metal. Thus, the electrode metal is worn by the sputtering. Further, the released electrode metal atoms are combined with mercury contained in the glass tube, so that the mercury vapor in the glass tube is consumed. Conventionally, Ni of the electrode metal is more liable to release atoms by the sputtering or has a higher sputtering rate. Hence the consumption of mercury is increased, so that the service life of the discharge tube is deteriorated.

Therefore, an attempt has recently been made to use a metal selected from Nb (niobium), Ti (titanium) and Ta (tantalum) and alloys of these metals each having a lower sputtering rate for the formation of the discharge electrodes as described in JP 2002-110085-A.

However, Ti is liable to absorb the discharge gas contained in the fluorescent discharge tube and, hence, is not suitable as the electrode material. Further, Ta is a very expensive metal material and, hence, is not suitable for mass production. Nb is free from these disadvantages, but more expensive than Ni. Further, Nb has a high melting point (2,793° C.), requiring a high welding temperature when a support conductor of W which also has a high melting point (3,653° C.) is welded to an Nb discharge electrode. Therefore, a relatively tight oxide film is liable to be formed on a welded portion. Where the discharge electrodes to which the support conductors are respectively welded are sealed in the glass tube with the oxide film left adhering on the discharge electrodes, the fluorescent film formed on the interior surface of the tube is liable to react with oxygen occurring due to decomposition of the oxide film during electric discharge and thereby, the fluorescent film is deteriorated. Therefore, the step of removing the oxide film formed on the electrode surface is required after the welding of the support conductor.

### SUMMARY OF THE INVENTION

In order to overcome the problems described above, preferred embodiments of the present invention provide a discharge electrode material which makes it possible to form a discharge electrode having a service life and discharge characteristics equivalent to those of a discharge electrode composed of pure Nb or a Nb alloy mainly composed of Nb and having excellent weldability to a support conductor while eliminating an oxide film removing step after welding and enabling significant reduction in material costs. Other preferred embodiments of the present invention provide a discharge electrode produced from the above-described unique discharge electrode material.

The inventors of the present invention carefully observed the wear of an Nb discharge electrode after a lapse of a service life of a fluorescent discharge tube, and discovered that an interior bottom portion of the cup-shaped discharge electrode was selectively worn to a depth of about 10 μm to about 20 μm. This led the inventors to conclude that inner surface portions of an end plate portion and a tubular portion of the cup-shaped discharge electrode each having a thickness of at least about 20 μm should be composed of Nb but outer portions of the end plate portion and the tubular portion may be composed of an oxidation resistant metal material having good weldability. Preferred embodiments of the present invention have been developed on the basis of such discoveries.

A discharge electrode clad material according to a preferred embodiment of the present invention includes a base layer composed of pure Ni or a Ni-based alloy mainly including Ni, and a surface layer bonded to the base layer and composed of pure Nb or a Nb-based alloy mainly including Nb, the surface layer having a thickness of not less than 20 μm and not greater than 100 μm.

In this double layer clad material, only the surface layer is composed of the pure Nb or the Nb-based alloy (hereinafter referred to simply as “Nb” when the pure Nb and the Nb-based alloy are not distinguished from each other) A cup-shaped discharge electrode is produced from the clad material with an inner surface portion thereof defined by the surface layer of the clad material, whereby only the inner surface portion virtually contributable to discharge is composed of Nb. Thus, material costs can be greatly reduced. In addition, the discharge electrode has a service life equivalent to that of a discharge electrode entirely composed only of pure Nb or an Nb-based alloy mainly composed of Nb, because the surface layer has a thickness of not less than 20 μm and not greater than 100 μm. Since the base layer is composed of the pure Ni or the Ni-based alloy (hereinafter referred to simply as “Ni” when the pure Ni and the Ni-based alloy are not distinguished from each other), the clad material is excellent in oxidation resistance and weldability to a support conductor. This makes it possible to eliminate the oxide film removing step, thereby reducing production costs.

The base layer of the clad material may be composed of a stainless steel as well as Ni. The stainless steel is highly resistant to oxidation, and very excellent in bondability to Nb. Since an outer portion of the discharge electrode is not virtually contributable to the discharge, the base layer of the stainless steel hardly influences discharge characteristics. Further, the material costs can be reduced as compared with a case in which the base layer is composed of Ni.

A clad material according to another preferred embodiment of the present invention includes a base layer composed of pure Ni or a Ni-based alloy mainly including Ni, an intermediate layer bonded to the base layer and composed of a ferrous material, and a surface layer bonded to the intermediate layer and composed of pure Nb or a Nb-based alloy mainly including Nb, the surface layer having a thickness of not less than 20 μm and not greater than 100 μm.

In this triple layer clad material, the bondability between the intermediate layer and the base layer and between the intermediate layer and the surface layer is very excellent, so that the bondability of the surface layer is improved. In addition, the use amount of the pure Ni or the Ni-based alloy can be reduced. Since front and rear surfaces of the intermediate layer are respectively covered with the surface layer and the base layer, so that the intermediate layer hardly needs oxidation resistance, the intermediate layer maybe composed of the ferrous material. The intermediate layer is preferably composed of a stainless steel, because a press-formed stainless steel product has a high strength.

The base layer may be composed of a Ni-based alloy including about 1.0 mass % to about 12.0 mass % of one or both of Nb and Ta, and the balance of Ni and inevitable impurities. The addition of the predetermined amount of Nb and Ta improves the corrosion resistance of the base layer to mercury vapor, thereby improving the durability of the discharge electrode.

In the double layer clad material, the base layer may have a strip-like shape, and the surface layer may include at least one elongated surface layer bonded onto a widthwise middle portion of the base layer between widthwise opposite edge portions of the base layer as extending longitudinally of the base layer. In the triple layer clad material, the intermediate layer may have a strip-like shape, and the base layer and the surface layer may respectively include at least one elongated base layer and at least one elongated surface layer provided between widthwise opposite edge portions of the intermediate layer as extending longitudinally of the intermediate layer.

Where the surface layer is disposed on the widthwise middle portion of the elongated base layer of the double layer clad material or the base layer and the surface layer are respectively disposed on widthwise middle portions of the elongated intermediate layer of the triple layer clad material, opposite edge portions of the clad material can be utilized as plate press margins or feed margins in a press-forming process. Since the bonding area of the surface layer (of the double layer clad material) or the bonding areas of the surface layer and the base layer (of the triple layer clad material) are reduced, the amounts of Nb and Ni used can be further reduced.

In the double layer clad material, the surface layer preferably has a thickness which is not greater than about 70% of the total thickness of the base layer and the surface layer. In the triple layer clad material, the surface layer preferably has a thickness which is not greater than about 70% of the total thickness of the base layer, the intermediate layer and the surface layer.

The pure Nb and the Nb-based alloy each have a great yield elongation. Therefore, when an Nb plate material is formed into a cup shape by deep drawing, Luders bands are formed in a tubular wall of the cup, so that the interior surface of the tubular wall is liable to be undulated. Where the tubular wall has undulations, a forming punch is liable to bite into projections of the undulations in the deep drawing process, thereby deteriorating the press formability. In the significant case, this makes it impossible to perform the forming operation. On the contrary, the base layer bonded onto the Nb surface layer (of the double layer clad material) or the base layer and the intermediate layer bonded onto the Nb surface layer (of the triple layer clad material) serve as aback-up layer for the surface layer, whereby deformation of the surface layer is suppressed to prevent the undulations of the surface layer which may otherwise occur due to the Luders bands. Therefore, excellent press formability can be ensured. If the thickness of the surface layer is greater than about 70% of the total thickness, it is difficult to suppress the occurrence of the undulations even with the provision of the back-up layer, thereby deteriorating the press formability. Therefore, the thickness of the surface layer is preferably not greater than about 70%, and more preferably not greater than about 60%, of the total thickness.

A discharge electrode according to at least one preferred embodiment of the present invention includes a tubular portion having an open end, and an end plate portion that is integral with the tubular portion to close the other end of the tubular portion, and is constructed of the above-described double layer or triple layer clad material by press forming with inner surfaces of the tubular portion and the end plate portion defined by the surface layer of the double layer or triple layer clad material.

Since the discharge electrode is produced by press forming as described above, the productivity is excellent. Further, only a portion of the discharge electrode that is virtually contributable to the discharge is composed of Nb, so that the material costs can be reduced without needlessly using Nb for formation of the other portion of the discharge electrode not contributable to the discharge. In addition, the discharge electrode has excellent weldability to a support conductor, and does not require the oxide film removing step after the support conductor is welded to the discharge electrode.

The foregoing and other elements, features, steps, characteristics and advantages of the present invention will become more apparent from the following detailed description of preferred embodiments with reference to the attached drawings.

### BRIEF DESCRIPTION OF THE DRAWINGS

FIG. 1 is a sectional view illustrating a major portion of a discharge electrode clad material according to a first preferred embodiment of the present invention.

FIG. 2 is a cross sectional view of a discharge electrode clad material according to a variation of the first preferred embodiment of the present invention.

FIG. 3 is a sectional view illustrating a major portion of a discharge electrode clad material according to a second preferred embodiment of the present invention.

FIG. 4 is a cross sectional view of a discharge electrode clad material according to a variation of the second preferred embodiment of the present invention.

FIG. 5 is a longitudinal sectional view of a discharge electrode for a fluorescent discharge tube according to the first preferred embodiment of the present invention.

FIG. 6 is a longitudinal sectional view of a fluorescent discharge tube according to the second preferred embodiment of the present invention.

FIG. 7 is a sectional view illustrating a major portion of a fluorescent discharge tube including a conventional discharge electrode.

### DETAILED DESCRIPTION OF PREFERRED EMBODIMENTS

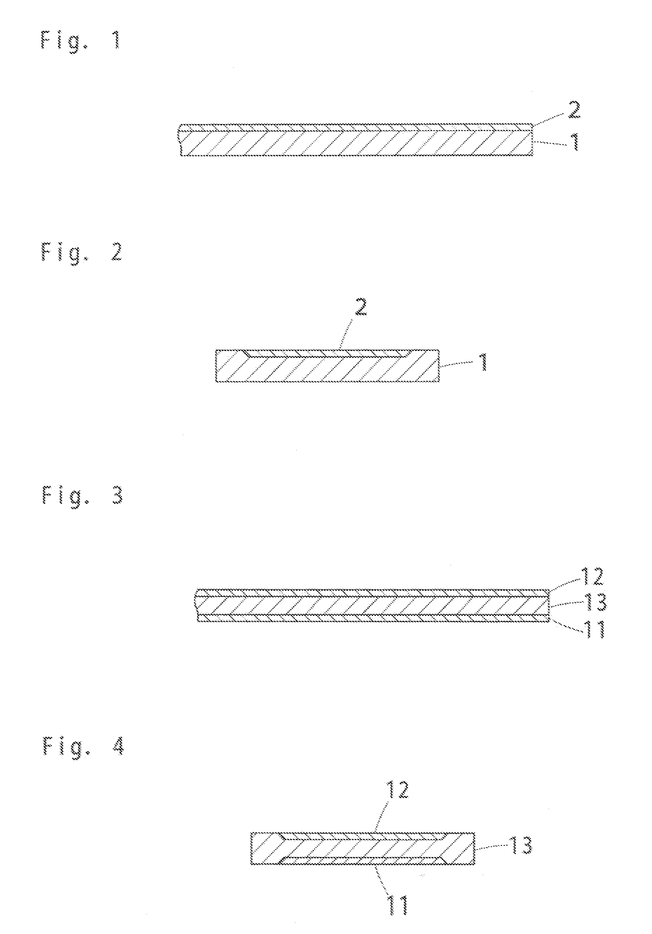

FIG. 1 is a sectional view of a discharge electrode double layer clad material according to a first preferred embodiment of the present invention. The clad material preferably includes abase layer 1 made of pure Ni, a Ni-based alloy mainly including Ni or a stainless steel, and a surface layer 2 made of pure Nb or a Nb-based alloy mainly including Nb. The surface layer 2 is bonded to the base layer 1 by roll pressure bonding and diffusion bonding. The pure Ni, the Ni-based alloy and the stainless steel are excellent in oxidation resistance, cold workability and deep drawability.

The Ni-based alloy preferably contains Ni in a proportion of not less than about 80 mass %, more preferably not less than about 85mass % . TheNb-based alloypreferably includes Nb in a proportion of not less than about 90 mass %, more preferably not less than about 95 mass %. Usable as the Ni-based alloy are an Ni—Nb alloy, a Ni—Ta alloy, and a Ni—Nb—Ta alloy, which preferably include about 1.0 mass % to about 12.0 mass % of one or both of Nb and Ta and the balance of Ni and inevitable impurities. The addition of the aforesaid amount of Nb and Ta does not adversely influence the formability, and is effective for improvement of corrosion resistance to mercury vapor, so that the durability of the resulting electrode is improved. Further, a Ni—W alloy, which preferably includes about 2.0 mass % to about 10 mass % of W and the balance of Ni, is usable as the Ni-based alloy. Like Nb and Ta, W also improves the corrosion resistance to the mercury vapor. In combination with Nb and/or Ta, W may be added to the Ni-based alloy but, in this case, a W content is preferably not greater than about 6.0%.

Usable as the stainless steel are various stainless steels including austenite stainless steels such as SUS304 and ferrite stainless steels such as SUS430. These stainless steels are more excellent in corrosion resistance, oxidation resistance and formability than the pure Ni and the Ni-based alloy, and have excellent diffusion-bondability to the surface layer. Particularly, the austenite stainless steels are preferred because of their excellent cold workability and their high strength after the forming.

The surface layer 2 composed of the pure Nb or the Nb-based alloy is required to have a thickness of at least about 20 μm in consideration of the wear of the discharge electrode, and preferably has a thickness of about 20 μm to about 100 μm, preferably about 40 μm to about 80 μm, in consideration of safety and thickness balance between the surface layer 2 and the other layer or the entire clad material. On the other hand, the clad material is required to have a thickness of about 0.1 mm to about 0.2 mm from the viewpoint of the deep drawability. Therefore, the thickness of the base layer 1 may be properly determined in consideration of the thickness of the surface layer 2 so as to meet the desired thickness of the clad material. From the viewpoint of the weldability of the discharge electrode to a support electrode, it is sufficient that the base layer 1 has a thickness of about 20 μm to about 50 μm. The thickness of the surface layer 2 is preferably not greater than about 70%, more preferably not greater than about 60%, of the total thickness of the surface layer 2 and the base layer 1 in order to ensure that the base layer 1 serves as the backup layer for prevention of deformation of the surface layer 2 and the clad material obtains a good press formability in a deep drawing process.

The surface layer 2 may be bonded onto the entire surface of the base layer 1 as shown in FIG. 1. Alternatively, as shown in FIG. 2, the clad material may be provided as a partial clad material in which the base layer 1 has a strip-like shape and an elongated surface layer 2 of Nb is bonded onto a middle portion of the base layer 1 except widthwise opposite edge portions of the base layer 1. Although the partial clad material is illustrated as having a single surface layer 2 in FIG. 2, a plurality of elongated surface layers may be arranged on the base layer as each extending longitudinally of the base layer.

Where cup-shaped discharge electrodes are continuously formed by utilizing the strip-like clad material, the opposite edge portions of the strip-like clad material serve as guide margins for feeding the clad material to a press and as plate press margins in the press forming process, and the middle portion of the clad material is continuously press-formed into cup-shaped discharge electrodes. After the forming process, the opposite edge portions are discarded. Therefore, it is not necessary to cover the opposite edge portions with an expensive Nb layer, but it is sufficient to provide the surface layer only on the middle portion of the base layer as in the partial clad material. Thus, the clad material provided in the form of the partial clad material allows material costs to be further reduced. More specifically, where cup-shaped discharge electrodes each having an outer diameter of about 1.7 mm and a length of about 5 mm are continuously formed by deep drawing, the middle portion of the clad material (with the single surface layer) to be used for the formation of the discharge electrodes has a width of about 8 mm, and the opposite edge portions each have a width of about 2 mm.

FIG. 3 is a sectional view of a discharge electrode triple layer clad material according to a second preferred embodiment of the present invention. The clad material preferably includes a base layer 11 composed of pure Ni or a Ni-based alloy, an intermediate layer 13 composed of a ferrous material, and a surface layer 12 composed of pure Nb or a Nb-based alloy. The base layer 11, the intermediate layer 13 and the surface layer 12 are pressure-bonded by rolling and diffusion-bonded to one another. Usable as the ferrous material of iron and steel are pure iron, a mild steel and a stainless steel. Any of various stainless steels may be used as the stainless steel, but an austenite stainless steel is preferred because of its high strength after the forming.

The base layer 11 and the intermediate layer 13 of this preferred embodiment correspond to the base layer 1 of the first preferred embodiment. In this preferred embodiment, the material costs can be reduced as compared with the case where the base layer 1 is entirely composed of the pure Ni or the Ni-based alloy. In addition, the diffusion bondability between the intermediate layer 13 and the base layer 11 and between the intermediate layer 13 and the surface layer 12 is very excellent.

As in the first preferred embodiment, the triple layer clad material commonly has a thickness of about 0.1 mm to about 0.2 mm. The base layer 11 preferably has a thickness of about 20 μm to about 50 μm for ensuring weldability to the support conductor. The surface layer 12 has a thickness of about 20 μm to about 100 μm as described above.

Like the double layer clad material, the triple layer clad material may be provided as a partial clad material as shown in FIG. 4. That is, the triple layer clad material may have a construction such that the intermediate layer 13 has a strip-like shape, and the base layer 11 and the surface layer 12 are bonded onto middle portions of the intermediate layer 13 of the clad material which are contributable to the formation of the cup-shaped discharge electrode.

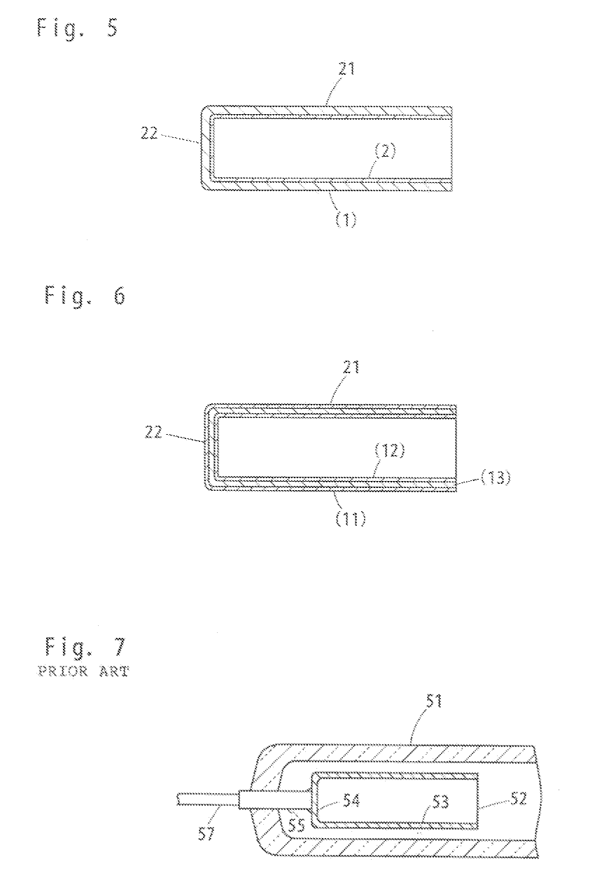

FIGS. 5 and 6 illustrate cup-shaped discharge electrodes (bottomed tubular discharge electrodes) which are produced from the double layer clad material according to the first preferred embodiment and the triple layer clad material according to the second preferred embodiment, respectively, by deep drawing. These discharge electrodes each include a tubular portion 21 having an open end and an end plate portion 22 formed unitarily with the tubular portion 21 to close the other end of the tubular portion 21, and each have an interior surface portion defined by the surface layer 2, 12 of the clad materials. When such a discharge electrode is used, a bottom interior surface portion of the discharge electrode is liable to be worn by discharge. Since the interior surface portion of the discharge electrode is defined by the surface layer 2, 12 of Nb, the discharge electrode has discharge characteristics and a service life equivalent to those of a discharge electrode composed of Nb alone when used in a fluorescent discharge tube, and the use amount of Nb is reduced. In addition, a support conductor can be easily welded to the discharge electrode by the provision of the base layer 1, 11.

For the production of the cup-shaped discharge electrode, a disk-shaped blank material is prepared by stamping the double layer or triple layer clad material, and then deep-drawn by press forming. The blank material may be stamped out with a portion thereof being connected to an outer periphery of the clad material via a connection portion. In this case, the cup-shaped discharge electrode is disconnected from the connection portion after the deep drawing.

A clad material production method will hereinafter be described.

To produce the double layer clad material, a Ni sheet as a material for the base layer 1 and a Nb sheet as a material for the surface layer 2 are stacked and pressure-bonded by rolling. That is, the Ni sheet and the Nb sheet thus stacked are cold-rolled through a pair of rolls to be pressure-bonded. To produce the triple layer clad material, a Ni sheet as a material for the base layer and a Nb sheet as a material for the surface layer are stacked on opposite surfaces of a ferrous material sheet as a material for the intermediate layer, and pressure-bonded together by rolling. A rolling reduction for the pressure bonding is commonly about 50% to about 70%. The pressure-bonded sheets are maintained at a temperature of about 900° C. to about 1,100° C. for several minutes for diffusion annealing. Since Nb is liable to react with N₂ and H₂, the diffusion annealing is preferably performed in the atmosphere of an inert gas (e.g., a noble gas) such as argon or in vacuum. Further, finishing cold rolling may follow the diffusion annealing, as required, for adjustment of the thickness of the clad material. After the finishing rolling, annealing may be performed under the same conditions as in the aforesaid diffusion annealing, as required, for softening the material.

The clad material thus produced is slit into elongated strips each having a proper width as required, and blank materials are stamped out of the elongated strips. Then, the blank materials are each press-formed. For preparation of the partial clad material shown in FIG. 2 or 4, the material sheets are preliminarily slit into elongated strips each having a desired width, and then the strips are subjected to pressure bonding by rolling, diffusion annealing and finishing rolling.

The present invention will be described more specifically by way of examples of preferred embodiments thereof. However, it should be understood that the present invention be not limited in any way by the following examples.

### EXAMPLE 1

Double layer clad material samples each including a base layer of pure Ni or a stainless steel (SUS304) and a surface layer of pure Nb diffusion-bonded to each other were prepared in the following manner.

A pure Ni sheet and a stainless steel sheet (each having a width of about 30 mm, a length of about 100 mm and a thickness of about 1.0 mm) were prepared as materials for the base layer, and a pure Nb sheet having the same width and length as those sheets (and a thickness of about 0.5 mm) was prepared as a material for the surface layer. The pure Ni sheet or the stainless steel sheet and the pure Nb sheet were sacked and pressure-bonded by cold rolling. Thus, a double layer pressure-bonded sheet having a thickness of about 0.6 mm was provided. The double layer press sheet was maintained at 1,050° C. in an argon gas atmosphere for three minutes for diffusion annealing, whereby a primary clad material was provided. After the annealing, the primary clad material was cold-rolled at a rolling reduction of about 75%, and then annealed under the same conditions as in the previous annealing, whereby a secondary clad material was provided. The base layer and the surface layer of the secondary clad material respectively had average thicknesses of about 0.1 mm and about 0.05 mm.

A triple layer clad material sample including a base layer of pure Ni, an intermediate layer of a stainless steel (SUS304) and a surface layer of pure Nb diffusion-bonded to one another in this order was prepared in the following manner.

A pure Ni sheet having a width of about 30 mm, a length of about 100 mm (and a thickness of about 0.8 mm) were prepared as a material for the base layer, and a stainless steel sheet having the same width and length as the pure Ni sheet (and a thickness of about 0.8 mm) was prepared as a material for the intermediate layer. Further, a pure Nb sheet having the same width and length as those sheets (and a thickness of about 0.8 mm) was prepared as a material for the surface layer. The pure Ni sheet, the stainless steel sheet and the pure Nb sheet were sacked and pressure-bonded by cold rolling. Thus, a triple layer pressure-bonded sheet having a thickness of about 0.75 mm was provided. The triple layer pressure-bonded sheet was diffusion-annealed under the same conditions as described above, whereby a primary clad material was provided. After the annealing, the primary clad material was cold-rolled at a rolling reduction of about 80%, and then annealed under the same conditions as in the previous annealing, whereby a secondary clad material was provided. The layers of the secondary clad material each have an average thickness of about 0.05 mm.

For comparison, a pure Ni thin plate, a pure Nb thin plate and a pure Mo thin plate (which are collectively referred to as “pure metal thin plates”) each having a thickness of about 0.15 mm were prepared. These thin plates were prepared by cold rolling and then subjected to annealing at 1,050° C. in an argon gas atmosphere for three minutes.

By utilizing the double layer secondary clad materials, the triple layer secondary clad material and the pure metal thin plates, cup-shaped discharge electrodes each having an outer diameter of about 1.7 mm, an inner diameter of about 1.5 mm and a tube length of about 5 mm as shown in FIGS. 5 and 6 were produced through a deep drawing process including eight drawing steps without intermediate annealing. None of these samples suffered from cracking and like problems in the deep drawing process. The discharge electrodes produced from the clad materials were each observed in section taken along the thickness of the tubular portion thereof, but no crack was found in the interfaces of the respective layers.

On the other hand, a support conductor composed of pure W and having an outer diameter of about 0.8 mm and a length of about 2.8 mm was prepared as a welding counterpart. The support electrode was butt-welded to (or welded in abutment against) a center portion of an outer surface of an end plate portion 22 of each of the cup-shaped discharge electrodes. The welding was performed under the following conditions, which were equivalent to optimum conditions to be used for welding the support conductor of W to a discharge electrode entirely composed of pure Ni.

(1) Welding Machine Herein Used

Butt welding machine: IS-120B available from Miyachi Technos

Transformer: IT-540 (having a winding ratio of 32)

(2) Welding Conditions

Voltage: 0.5V to 1.0V

Current: 300 A to 800 A

The welding strength of a portion of the cup-shaped discharge electrode welded to the support electrode was measured in the following manner. The discharge electrode and the support conductor were held by clamps and pulled in opposite directions by a tensile tester. A maximum tensile strength observed when the support conductor was disconnected from the discharge electrode was determined as the welding strength. In practice, it is sufficient that the welding strength is not smaller than 100N.

A sputtering test piece (10 mm×10 mm) was sampled from each of the clad materials and the pure metal thin plates, and a sputtering rate was measured in the following manner. First, a test surface of the sampled test piece was polished to be mirror-finished. In an ion beam apparatus (Model VE-747 available from Veeco), the test piece was used as a target, and a voltage of 500V was applied between the target and a substrate and then argon ions (1.3×10⁻⁶ Torr) were accelerated to impinge on the test surface for a predetermined period (120 min) for sputtering. A portion of the mirror-finished test surface was masked to define a non-sputtering portion. After the sputtering, a step was formed on a boundary between a portion of the mirror-finished surface of the test piece partly worn by the sputtering and the masked non-sputtering portion. The step was measured by a contact roughness meter (Model DEKTAK2A available from Sloan), and the sputtering rate (Å/min) was determined from the following expression: Sputtering rate=Step(Å)/Sputtering period (120 min) The welding strength and the sputtering rate thus determined shown in Table 1.

TABLE 1

| Sam- | | Welding | Sputtering | |
|---|---|---|---|---|
| ple | | strength | rate | |
| No. | Structure of sample | (N) | Å/min | Remarks |
| 1 | Pure Ni thin plate | 130 | 242 | Comparative |
| | | | | example |
| 2 | Pure Nb thin plate | (Unable to weld) | 117 | Comparative |
| | | | | example |
| 3 | Pure Mo thin plate | (Unable to weld) | 171 | Comparative |
| | | | | example |
| 4 | Ni/Nb clad material | 130 | 117 | Inventive |
| | | | | example |
| 5 | Ni/SUS/Nb clad | 130 | 117 | Inventive |
| | material | | | example |
| 6 | SUS/Nb clad | 130 | 117 | Inventive |
| | material | | | example |

As can be understood from Table 1, the clad materials of Samples No. 4, No. 5 and No. 6 (Inventive Examples) each had excellent deep drawability, sufficient weldability with a welding strength of not smaller than about 100N, and a sputtering rate equivalent to that of pure Nb.

On the other hand, the pure Ni material of Sample No. 1 (Comparative Example) had sufficient weldability, but was poor in durability with a higher sputtering rate. The pure Nb material and the pure Mo material of Samples No. 2 and No. 3 (Comparative Examples) were poor in weldability, because these materials each had a high melting point and the welding under the aforesaid welding conditions was impossible. Further, the pure Mo material had a high sputtering rate and was easily worn by the sputtering regardless of a high melting point.

### EXAMPLE 2

Double layer clad materials each including a base layer of pure Ni (Ni layer) and a surface layer of pure Nb or pure Mo (Nb layer or Mo layer) bonded to each other were prepared in the following manner.

Ni sheets having a width of about 30 mm, a length of about 100 mm and different thicknesses were prepared as materials for the base layer, and pure Nb sheets and pure Mo sheets having the same width and length as the Ni sheets and different thicknesses were prepared as materials for the surface layer. The Ni sheets and the pure Nb sheets or the pure Mo sheets were sacked as making various combinations each having a material for the base layer and a material for the surface layer, and respectively pressure-bonded by cold rolling. Thus, double layer pressure-bonded sheets each having a thickness of about 0.6 mm were provided. The double layer pressure-bonded sheets were maintained at 1,050° C. in an argon gas atmosphere for three minutes for diffusion annealing, whereby primary clad materials were provided. After the annealing, the primary clad materials were cold-rolled at a rolling reduction of about 75%, and then annealed under the same conditions as in the previous annealing, whereby secondary clad materials were provided. The secondary clad materials each had a total thickness of about 0.15 mm, and the base layers (Ni layers) and the surface layers (Nb layers or Mo layers) of the respective secondary clad materials each had an average thickness as shown in Table 2.

For comparison, a pure Ni thin plate (Sample No. 11 in Table 2) having a thickness of about 0.15 mm was prepared. This thin plate was cold-rolled, and then maintained at 1,050° C. in an argon gas atmosphere for three minutes for annealing.

Next, sputtering test pieces (10 mm×10 mm) were sampled from the clad materials and the pure metal thin plate of the respective samples, and a removal time required for completely removing each of the 0.15 mm thick test pieces by sputtering was measured under the same conditions as in Examples 1. A removal time ratio was determined by dividing the removal time by the time required for removing the pure Ni thin plate by sputtering. The results are also shown in Table 2.

By utilizing the respective samples, cup-shaped discharge electrodes each having an outer diameter of about 1.7 mm, an inner diameter of about 1.5 mm and a tube length of about 5 mm were produced through a deep drawing process including eight drawing steps without intermediate annealing as in Examples 1. The interior surfaces of the tubular portions of the resulting products (cup-shaped discharge electrodes) were observed. The results of the observation are also shown in Table 2.

TABLE 2

| | Thickness (μm) | | | Surface layer | Removal | | |
|---|---|---|---|---|---|---|---|
| Sample | Ni | Nb | Mo | thickness ratio | time | Deep | |
| No. | layer | layer | layer | (%) | ratio | drawability | Remarks |
| 11 | 150 | — | — | — | 1.00 | Excellent | Comparative |
| | | | | | | | example |
| 12 | 140 | 10 | — | 7 | 1.07 | Base layer | Comparative |
| | | | | | | exposed | example |
| 13 | 140 | — | 10 | 7 | 1.03 | Base layer | Comparative |
| | | | | | | exposed | example |
| 14 | 130 | — | 20 | 13 | 1.06 | Excellent | Comparative |
| | | | | | | | example |
| 15 | 130 | 20 | — | 13 | 1.14 | Excellent | Inventive |
| | | | | | | | example |
| 16 | 90 | 60 | — | 40 | 1.43 | Excellent | Inventive |
| | | | | | | | example |
| 17 | 50 | 100 | — | 67 | 1.71 | Slight | Inventive |
| | | | | | | undulations | example |
| 18 | 40 | 110 | — | 73 | 1.86 | Multiple | Comparative |
| | | | | | | undulations | example |

As can be understood from Table 2, the clad materials of Samples No. 15, No. 16 and No. 17 (Inventive Examples) were excellent in removal time ratio with respect to the pure Ni thin plate of Sample No. 11, and the sputtering resistance was improved with an increase in the thickness of the surface layer. Samples No. 15 and No. 16 were excellent in deep drawability. As for Sample No. 17, slight undulations attributable to Luders bands were observed on the interior surface of the tubular portion of the product, but its deep drawing was performed without problems.

The surface layers of the clad materials of Samples No. 12 and No. 13 (Comparative Examples) each had a small thickness (e.g., about 10 μm), so that the base layers were partly exposed from the surface layers on the interiors of the products. Sample No. 14 (Comparative Example) was excellent in deep drawability, but the sputtering removal time ratio was much smaller than Sample No. 15 (Inventive Example) which had the same surface layer thickness. Therefore, it was confirmed that Mo was poorer in the sputtering resistance than Nb. Sample No. 18 (Comparative Example) was very poor in deep drawability and a multiplicity of undulations were observed on the interior surface of the tubular portion of the product, because the surface layer thickness was greater than about 70% of the total thickness. As a result, a forming punch bit into projections of the undulations, failing to produce the cup-shaped discharge electrode by the deep drawing.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

1-15. (canceled)

16. A discharge electrode clad material comprising:
a base layer composed of pure Ni or a Ni-based alloy mainly including Ni; and
a surface layer bonded to the base layer and composed of pure Nb or a Nb-based alloy mainly including Nb, the surface layer having a thickness of not less than about 20 μm and not greater than about 100 μm.

17. A discharge electrode clad material comprising:
a base layer composed of a stainless steel; and
a surface layer bonded to the base layer and composed of pure Nb or a Nb-based alloy mainly including Nb, the surface layer having a thickness of not less than about 20 μ, and not greater than about 100 μm.

18. A discharge electrode clad material comprising:
a base layer composed of pure Ni or a Ni-based alloy mainly comprising Ni;
an intermediate layer bonded to the base layer and composed of a ferrous material; and
a surface layer bonded to the intermediate layer and composed of pure Nb or a Nb-bases alloy mainly including Nb, the surface layer having a thickness of not smaller than about 20 μm and not greater than about 100 μm.

19. A discharge electrode clad material as set forth in claim 18, wherein the ferrous material is a stainless steel.

20. A discharge electrode clad material as set forth in claim 16, wherein the Ni-based alloy of the base layer includes not less than about 1.0 mass % and not greater than about 12.0 mass % of one or both of Nb and Ta, and the balance of Ni and inevitable impurities.

21. A discharge electrode clad material as set forth in claim 17, wherein the Ni-based alloy of the surface layer includes not less than about 1.0 mass % and not greater than about 12.0 mass % of one or both of Nb and Ta, and the balance of Ni and inevitable impurities.

22. A discharge electrode clad material as set forth in claim 18, wherein the Ni-based alloy of the base layer includes not less than about 1.0 mass % and not greater than about 12.0 mass % of one or both of Nb and Ta, and the balance of Ni and inevitable impurities.

23. A discharge electrode clad material as set forth in claim 19, wherein the Ni-based alloy of the base layer includes not less than about 1.0 mass % and not greater than about 12.0 mass % of one or both of Nb and Ta, and the balance of Ni and inevitable impurities.

24. A discharge electrode clad material as set forth in claim 16, wherein the base layer has a strip-like shape, and the surface layer includes at least one elongated surface layer bonded onto a portion of the base layer between widthwise opposite edge portions of the base layer as extending longitudinally of the base layer.

25. A discharge electrode clad material as set forth in claim 17, wherein the base layer has a strip-like shape, and the surface layer includes at least one elongated surface layer bonded onto a portion of the base layer between widthwise opposite edge portions of the base layer as extending longitudinally of the base layer.

26. A discharge electrode clad material as set forth in claim 18, wherein the intermediate layer has a strip-like shape, and the base layer and the surface layer respectively include at least one elongated base layer and at least one elongated surface layer bonded onto portions of the intermediate layer between widthwise opposite edge portions of the intermediate layer as extending longitudinally of the intermediate layer.

27. A discharge electrode clad material as set forth in claim 16, wherein the surface layer has a thickness which is not greater than about 70% of a total thickness of the base layer and the surface layer.

28. A discharge electrode clad material as set forth in claim 18, wherein the surface layer has a thickness which is not greater than about 70% of a total thickness of the base layer, the intermediate layer and the surface layer.

29. A discharge electrode comprising:
a unitary press-formed body made of the clad material according to claim 16;
a tubular portion having an open end; and
and end plate portion that is integral with the tubular portion to close the other end of the tubular portion; wherein
inner surfaces of the tubular portion and the end plate potion are defined by a surface layer of the clad material.

30. A discharge electrode comprising:
a unitary press-formed body made of the clad material according to claim 17;
a tubular portion having an open end; and
an end plate portion that is integral with the tubular portion to close the other end of the tubular portion; wherein
inner surfaces of the tubular portion and the end plate potion are defined by a surface layer of the clad material.

31. A discharge electrode comprising:
a unitary press-formed body made of the clad material according to claim 18;
a tubular portion having an open end; and
an end plate portion that is integral with the tubular portion to close the other end of the tubular portion; wherein
inner surfaces of the tubular portion and the end plate potion are defined by a surface layer of the clad material.
